(19) United States
(12) Patent Application Publication
(10) Pub. No.: US 2006/0191767 A1
(43) Pub. Date: Aug. 31, 2006

(54) Clutch disk

(75) Inventors: Martin Hassler, Karlsruhe (DE); Alain Rusch, Waldolwisheim (DE)

Correspondence Address: ALFRED J MANGELS, 4729 CORNELL ROAD, CINCINNATI, OH, 452412433, US

(73) Assignee: LuK Lamellen und Kupplungsbau Beteiligungs KG, Buhl (DE)

(21) Appl. No.: 11/352,934

(22) Filed: Feb. 11, 2006

(30) Foreign Application Priority Data
Feb. 16, 2005 (DE) 10 2005 006 913.4

(51) Int. Cl. F16D 13/64

(52) U.S. Cl. 192/107 C; 192/52.6

(57) ABSTRACT

A clutch disk for use with a vehicle clutch having a carrier plate to which facing carrier elements are attached that are pretensioned against each other in the axial direction. On their sides that face away from each other axially, there is at least one facing mount surface onto which at least one clutch facing is attached.

### BACKGROUND OF THE INVENTION

1. Field of the Invention

The invention relates to a clutch disk, in particular for use with a vehicle clutch, having a carrier plate to which facing carrier elements are attached that are pretensioned against each other in axial direction and that have, on sides that are turned away axially from each other, at least one facing mount surface onto which at least one clutch facing is attached.

2. Description of the Related Art

The object of the invention is to provide a clutch disk, in particular for use in a motor vehicle clutch, having a carrier plate to which facing carrier elements are attached that are pretensioned against each other in axial direction and that have, on sides that are turned away axially from each other, at least one facing mount surface onto which at least one clutch facing is attached, which enables improved axial pretensioning and is economical to produce.

### SUMMARY OF THE INVENTION

The object is achieved with a clutch disk, in particular for use in a motor vehicle clutch, having a carrier plate to which facing carrier elements are attached that are pretensioned against each other in an axial direction and that have, on sides that are turned away from each other in axial direction, at least one facing mount surface to which at least one clutch facing is attached, by the fact that the facing carrier elements on the side being turned away from the facing mount surface in axial direction having at least one facing contact surface for a clutch facing each, which is positioned opposite the clutch facing that is attached to the respective facing carrier element. By means of the design of the clutch disk as described above and in the following explanation, it is possible to reduce the mass moment of inertia and the tensioned thickness of the clutch disk. The facing carrier elements, which are pretensioned against each other, have both their carrier function and also the function of spring elements, by which the opposing clutch facing are pretensioned against each other. Hence the facing carrier elements, according to the invention, are combined facing carrier elements and spring elements.

A preferred exemplary embodiment of the clutch disk is characterized by the fact that the facing mount surface is formed by an adhesive surface. The adhesive surface is preferably of flat design. It is also possible however to attach the clutch facings to the facing mount surface otherwise, for example with the help of rivets.

Another preferred exemplary embodiment is characterized by the fact that the facing contact surface is separated from the facing mount surface by at least one corrugation. The corrugation makes it possible to create different levels in axial direction on a facing carrier element in a simple manner.

Another preferred exemplary embodiment of the clutch disk is characterized by the fact that the facing mount surface of one facing carrier element is positioned between two supporting surfaces, on which corresponding supporting surfaces of at least one additional facing carrier element are supported when the clutch disk is in its assembled state. That makes it possible to achieve great robustness of the facing spring effect produced by the facing carrier elements.

Another preferred exemplary embodiment of the clutch disk is characterized by the fact that a step is formed in the facing carrier element between the facing mount surface and the facing contact surface. The step makes it possible to guide one facing carrier element behind a facing carrier element which is opposite in axial direction.

Another preferred exemplary embodiment of the clutch disk is characterized by the fact that the dimension of the step in axial direction corresponds approximately to the material thickness of the facing carrier element. That provides the advantage that in the sprung, tensioned state in the area where the facing carrier elements are arranged one behind another, neither unwanted high tensions nor increased contact with the facing occurs.

Another preferred exemplary embodiment of the clutch disk is characterized by the fact that the facing carrier elements each have an essentially right-angled cutout. In the area of the cutout, facing carrier elements that are opposite each other in axial direction can be guided one behind the other. The cutout can have the shape for example of a slot, an eruption or a notch.

Other preferred embodiments of the clutch disk are characterized by the fact that when the clutch disk is in its assembled state, the facing carrier elements each have two tongues radially inside or outside of the facing mount surface, each having at least one facing contact surface for a clutch facing that is located opposite the clutch facing which is attached to the respective facing carrier element. Preferably there is also at least one supporting surface on each of the tongues, on which a corresponding supporting surface of another facing carrier element is supported when the clutch disk is in its assembled state.

Another preferred exemplary embodiment of the clutch disk is characterized by the fact that, when the clutch disk is in its assembled state, the facing carrier elements are meshed with adjacent facing carrier elements in circumferential direction. That creates a stable composite of the facing carrier elements when the clutch disk is in its assembled state.

Another preferred exemplary embodiment of the clutch disk is characterized by the fact that the facing carrier elements each have at least one window that serves, in case the clutch disk is in its assembled state, to retain the facing contact surface for the clutch facing that is opposite to the clutch facing which is attached to the particular facing carrier element. Preferably the windows are essentially of rectangular shape.

Another preferred exemplary embodiment of the clutch disk is characterized by the fact that the facing carrier elements have at least one tongue each, on which the facing contact surface is provided for the clutch facing which is opposite the clutch facing that is attached to the particular facing carrier element. The tongues are preferably made in a single piece together with the facing carrier element.

Another preferred exemplary embodiment of the clutch disk is characterized by the fact that all of the facing carrier elements have the same form. This greatly simplifies the production of the clutch disk according to the invention.

Another preferred exemplary embodiment of the clutch disk is characterized by the fact that the facing carrier elements have a mount segment radially on the inside. The mount segment includes, for example, a plurality of clearance holes to receive attaching rivets, with the help of which the facing carrier elements are attached to the carrier plate.

Another preferred exemplary embodiment of the clutch disk is characterized by the fact that the facing carrier elements are each made of spring steel in a single piece. That ensures simplicity of manufacture and good springiness of the facing carrier elements.

### BRIEF DESCRIPTION OF THE DRAWINGS

Additional advantages, characteristics and details of the invention are evident from the following description, in which various embodiments are described in detail with reference to the drawing. The characteristics mentioned in the claims and in the description may be essential to the invention individually or in combination. In the drawing figures:

FIG. 1 is a perspective representation of an embodiment of a clutch disk ion accordance with the invention;

FIG. 2 is an enlarged detail of FIG. 1;

FIG. 3 shows the clutch disk of FIG. 1 in a top view;

FIG. 4 is a cross-sectional view taken along the line IV-IV of FIG. 3;

FIG. 5 is a top view of a single facing carrier element in accordance with a first exemplary embodiment;

FIG. 6 is a cross-sectional view taken along the line VI-VI of FIG. 5;

FIG. 7 is a cross-sectional view taken along the line VII-VII of FIG. 5;

FIG. 8 is a cross-sectional view taken along the line VIII-VIII of FIG. 5;

FIG. 9 is an enlarged view of detail IX of FIG. 8;

FIG. 10 is a perspective view of the facing carrier element that is shown in various views in FIGS. 5 through 9;

FIGS. 11 and 12 are perspective views of facing carrier elements in accordance with additional exemplary embodiments; and

FIGS. 13 to 33 are perspective views of facing carrier elements in accordance with additional exemplary embodiments, wherein the upper figure on each of drawing sheets 7 through 16 shows two facing carrier elements in the assembled state.

### DESCRIPTION OF THE PREFERRED EMBODIMENTS

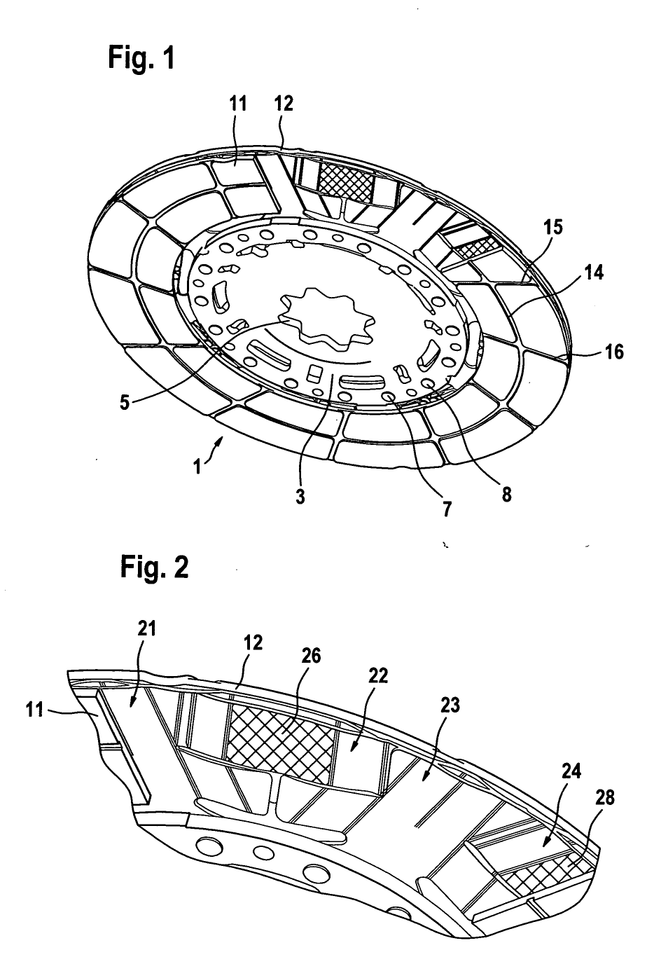

Referring now to the drawings, FIG. 1 shows a clutch disk 1 in perspective view and partially detached. Clutch disk 1 includes a carrier plate 3, which has a central hub 5. The hub 5 has a tooth profile through which the carrier plate 3 can be connected to a transmission input shaft (not shown) in a positive locked and rotationally fixed connection. Clutch disk 1 is part of a clutch of a motor vehicle, whose basic construction and function are assumed to be known to those skilled in the art.

Radially on the outside the carrier plate 3 has a multitude of clearance holes whose function it is to attach facing carrier elements to carrier plate 3 with the help of rivet connections 7, 8. Clutch facings 11, 12 in turn can be attached to the facing carrier elements. Clutch facing 11 has a circumferential groove 14 and a plurality of radial grooves 15, 16. Segments are formed on the surface of the single-piece clutch facing 11 by the circumferential groove 14 and the radial grooves 15, 16. The clutch facing 11 can also be made in more than one piece.

FIG. 2 shows a detail of FIG. 1 in an enlarged view. In the shown detail, part of facing 11 is removed, so that facing carrier elements 21 through 24, pretensioned in axial direction between the clutch facings 11, 12, are partially visible. In the context of the present invention the term axial refers to the rotational axis of clutch disk 1. Facing carrier element 22 has a facing mount surface 26, which is shown crosswise hatched. Facing carrier element 24 has a facing mount surface 28, which also is shown crosswise hatched. In this and the subsequent exemplary embodiments, all facing mount surfaces, that are also designated as facing mount segments, are shown crosswise hatched. The facing mount surfaces 26 and 28 are flat in shape and form facing cementing surfaces, which are also designated as facing cementing segments and onto which parts of the clutch facing 11 are cemented.

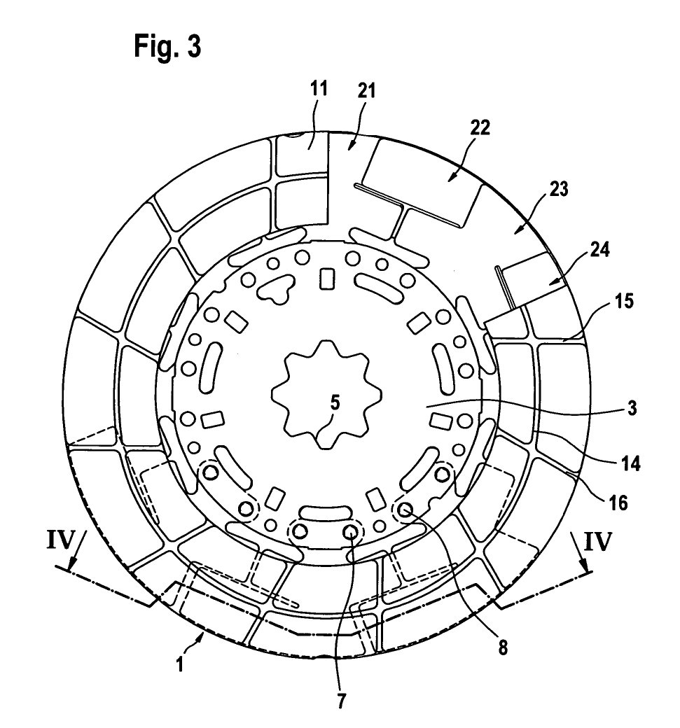

FIG. 3 shows clutch disk 1 of FIG. 1 in a top view.

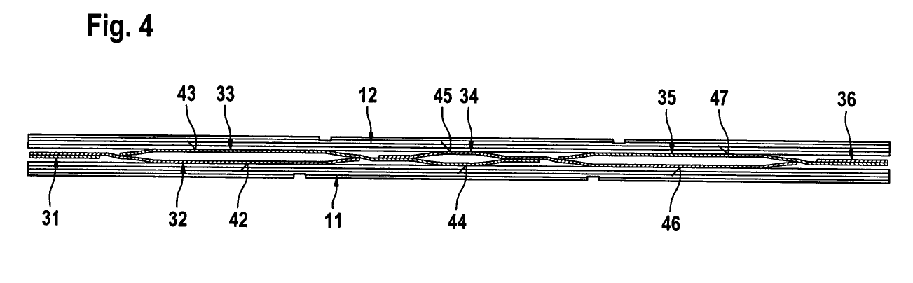

FIG. 4 shows the view of a section along the line IV-IV in FIG. 3. In the sectional view it can be seen that the clutch facings 11 and 12 are pretensioned against each other at a prescribed interval by facing carrier elements 31 through 36. Facing carrier element 32 has a facing cementing surface 42 onto which a part of clutch facing 11 is cemented. Located adjacent to facing cementing surface 42 in the axial direction is a facing cementing surface 43, which is provided on facing carrier element 33 and onto which part of clutch facing 12 is cemented. Adjacent to facing cementing surfaces 42 and 43 in circumferential direction are the facing contact surfaces 44 and 45. Facing contact surface 44 is formed on the facing carrier element in such a way that clutch facing 11 is in contact with facing contact surface 44. So clutch facing 12 is attached to facing cementing surface 43 of facing carrier element 33, while clutch facing 11, which lies opposite in axial direction, is in contact with facing contact surface 44 of facing carrier element 33. Facing contact surface 45 is formed on facing contact element 34. Clutch facing 12 is in contact with facing contact surface 45. Facing carrier element 34 has a facing cementing surface 46, onto which clutch facing 11 is cemented. Positioned opposite facing cementing surface 46 is a facing cementing surface 47, onto which clutch facing 12 is cemented, and which is provided on facing carrier element 35.

In FIG. 4 it can be seen, starting from the left, that one end of facing carrier element 31 is in contact with facing carrier element 32. Furthermore, the left end of facing carrier element 33 is in contact with facing carrier element 32. The right end of facing carrier element 32 is in contact with facing carrier element 33. The left end of facing carrier element 34 is also in contact with facing carrier element 33. The right end of facing carrier element 33 is in contact with facing carrier element 34. The left end of facing carrier element 35 is also in contact with facing carrier element 34. The right end of facing carrier element 34 is in contact with facing carrier element 35. The left end of facing carrier element 36 is in contact with facing carrier element 35. This ensures a stable composite and good springiness of the facing carrier elements in axial direction when the clutch disk is in its assembled state.

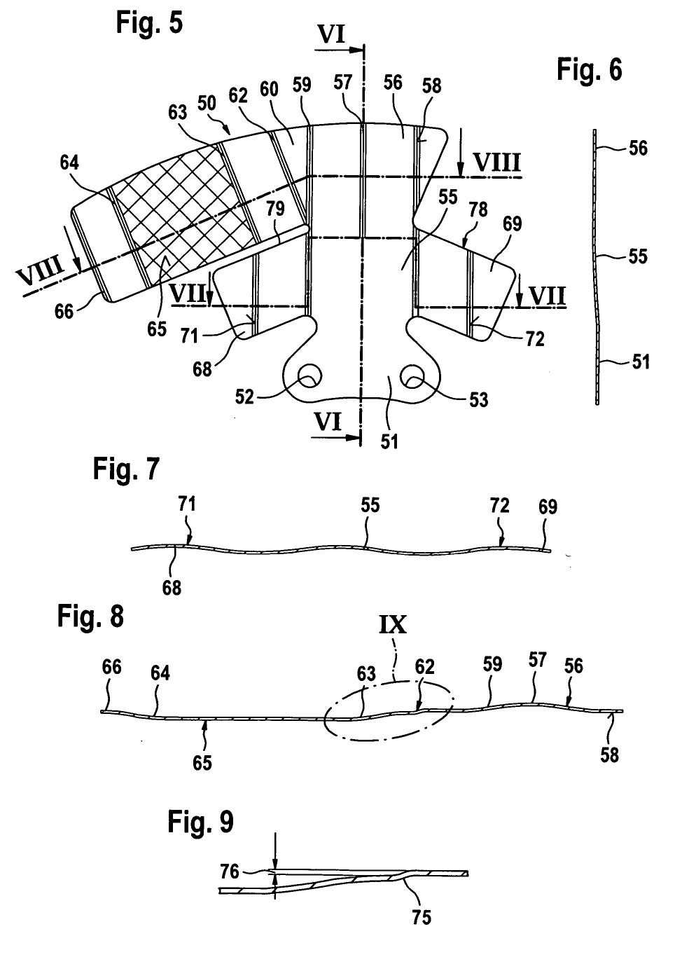

FIGS. 5 through 8 show various views of a facing carrier element 50 of the exemplary embodiment shown in FIGS. 1 through 4. Facing carrier element 50 has a facing mount segment 51, which has substantially the shape of a truncated triangle. There are two clearance holes 52, 53 in mount segment 51. Clearance holes 52, 53 are used to pass through attaching rivets, by which facing carrier element 50 is attachable to the carrier plate (3 in FIG. 1). From mount segment 51 a connecting segment 55, which is substantially of rectangular shape, extends in radial direction. In the context of the present invention the term radial is referenced to the rotational axis of the clutch disk (1 in FIG. 1). Radially towards the outside, connecting segment 55 merges into a contact segment 56, which is also substantially of rectangular shape. Contact segment 56 has an undulation 57 in its center, which extends in radial direction. Contact segment 56 is bound laterally by two undulations 57, 58, which are positioned parallel to undulation 57. Undulation 57 forms a contact surface for a clutch facing. Undulations 58, 59 form supporting surfaces on the opposite side in axial direction for at least one facing carrier element which is adjacent in axial direction. Radially towards the outside, contact segment 56 transitions at undulation 59 into a triangular projection 60, which is bound by undulation 59 and an undulation 62, which together with undulation 59 makes substantially the shape of a V. Triangular projection 60 transitions into a wing 61, which extends substantially in circumferential direction. The term circumferential direction likewise refers to the rotational axis of the clutch disk (1 in FIG. 1). Wing 61 is equipped with three undulations 62 through 64, which are arranged parallel to each other and at an angle of about 20 degrees from undulation 59. Undulations 61 and 64 bound a facing cementing surface 65. At its free end, wing 61 has an undulation 66 which forms a supporting surface for an additional facing carrier element. Undulations 59, 62 and 58 also form supporting surfaces for additional facing carrier elements.

Radially towards the inside, two tongues 68, 69 emanate from connecting segment 55, each of which has an undulation 71, 72. The undulations 71, 72 form contact surfaces for the clutch facing, which is also in contact with undulation 57. Here undulations 57 and 71, 72 are located opposite of facing cementing surface 65 in axial direction, as can be seen from the sectional views in FIGS. 7 and 8.

It can be seen in FIG. 9, that a step 75 is formed on facing carrier element 50 between undulation 59 and undulation 63. The height 76 of step 75 corresponds approximately to the thickness of facing carrier element 50. This enables attachment in a simple way to other facing carrier elements that are designed exactly the same as facing carrier element 50.

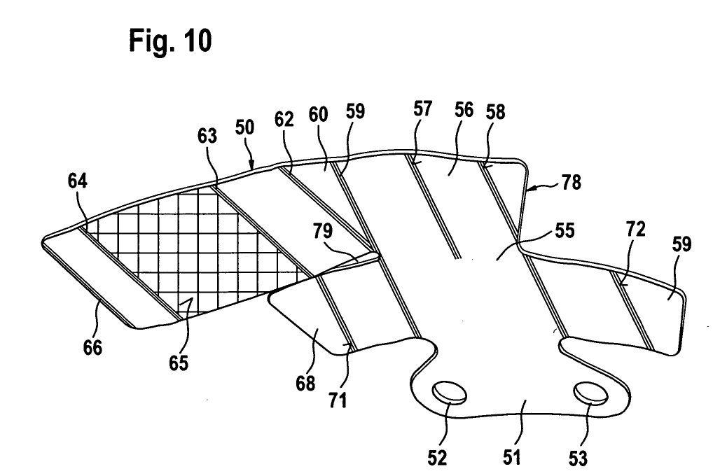

FIG. 10 shows a perspective view of facing carrier element 50. In order to arrange two facing carrier elements 50, one after the other in axial direction, as indicated in FIG. 2, facing carrier element 50 has a cutout 78 and a slot 79. In FIGS. 1 through 4 it can be seen that identical facing carrier elements are arranged one behind the other in axial direction and overlapping in circumferential direction. The directions of the undulations and the facing cementing surfaces are designed and arranged so that when the facing carrier elements are put under spring tension, the only motions that occur produce no shear stresses in the cementing areas. In the area of step 75 at the level of the material thickness a facing carrier element can be driven behind a facing carrier element, which is opposite in axial direction. That has the advantage that under spring tension, at the location where one piece passes behind the other, there are neither high tensions in the facing carrier elements nor are there elevated contact pressures with the clutch facings. The fact that the layer of facing carrier elements on the transmission side is cemented with the facing on the flywheel and the layer of facing carrier elements on the flywheel side is cemented with the clutch facing on the transmission and that the facing carrier elements are guided one behind the other for this purpose means a limitation of axial expansion of the arrangement, similar to the limitation which is guaranteed by stepped rivets in a conventional double segment facing springing. For this reason it is also possible, with facing carrier elements according to the invention, to realize riveted double segment facing springing, where simple hollow rivets can be employed instead of the stepped rivets. Accordingly, as well it is possible here to reduce the facing thickness being necessary to ensure a certain reserve of abrasion.

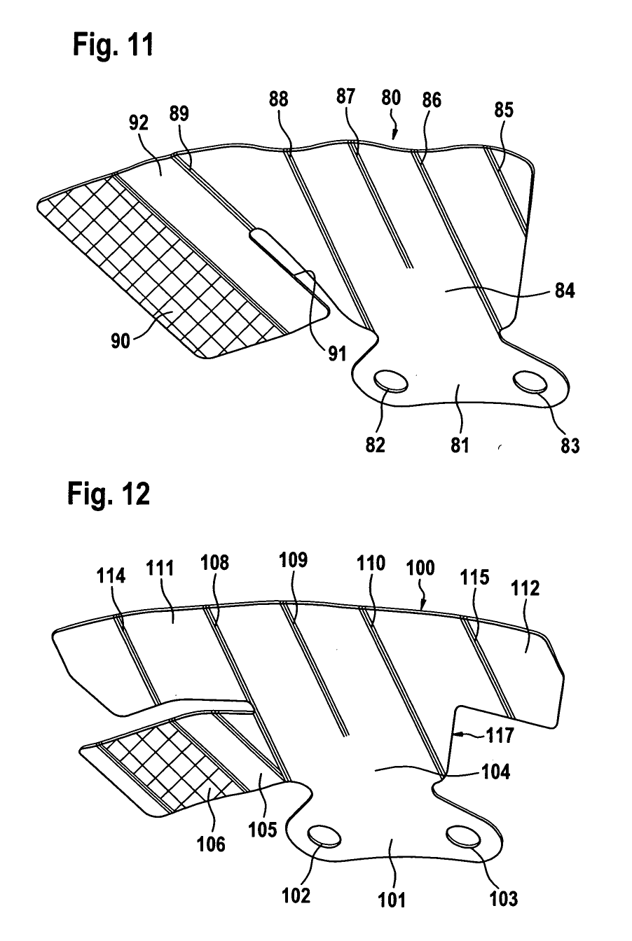

FIG. 11 shows a perspective view of a facing carrier element 80 according to another exemplary embodiment. Facing carrier element 80 has a mount segment 81 with two clearance holes 82 and 83. Projecting from mount segment 81 is a segment 84 that extends radially outward. In segment 84, undulations 85 through 88 are formed, which extend in the direction of a radial, parallel to each other. The expanded segment 84 is bound on its left side by a shaft 89, which is inclined at an angle of about 20 degrees to the undulation 88. Projecting from the undulation 89 is a tongue 92, which has a facing mount segment 90. Elongating the undulation 89, there is a slot 91 between the tongue 92 and the segment 84 extending radially outward. In the area of undulations 85 and 87 the facing carrier element 80 extends outward into the plane of the paper. In the area of undulations 86, 88 the facing carrier element 80 extends outward from the plane of the paper. In the same way, the facing mount surface 90, which is also known as a facing mount segment, is set off from undulations 87 and 85 in the axial direction.

FIG. 12 shows a perspective view of a facing carrier element 100 with a mount segment 101. Mount segment 101 has two clearance holes 102 and 103. Projecting from mount segment 101 is a segment 104 that extends radially outward. Projecting radially inward from segment 104 is a tongue 105 which has a facing mount surface 106. In addition, segment 104 has an undulation 109 in the middle which extends radially outward. Parallel to undulation 109, facing carrier element 100 has undulations 108 and 110 which bound segment 104 laterally. Tongues 111 and 112 project radially outward from segment 104. Tongue 111 has an undulation 114 which extends parallel to undulation 109. In the same way, tongue 112 has an undulation 115. On the side opposite the tongue 105 the facing carrier element 100 has a cutout 117 for passing through behind another facing carrier element (not shown), which is shaped exactly like facing carrier element 100.

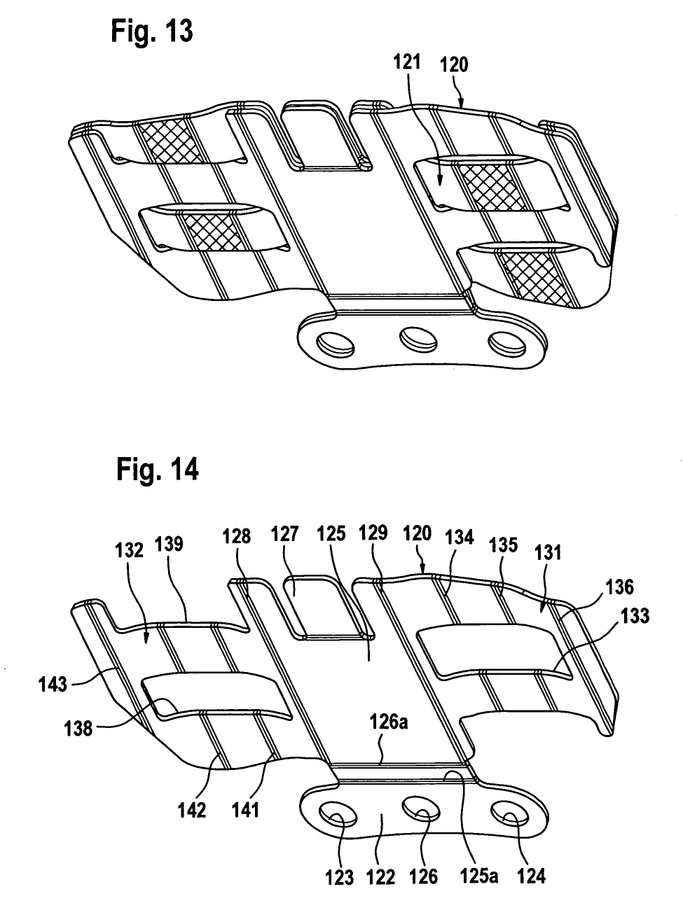

FIG. 13 shows a perspective view of two facing carrier elements 120, 121, which are identical in construction and partially in contact with each other. The construction and the function of the facing carrier elements 120, 121 are explained in reference to FIG. 14, using the example of facing carrier element 120.

In FIG. 14 it can be seen that facing carrier element 120 has a mount element 122 in which there are three clearance holes 123, 124 and 126. Mount segment 122 is bound in the radial direction toward the outside by an undulation 125a which runs perpendicular to a radial. Parallel to undulation 125a is an additional undulation 126a, from which a rectangular shaped segment 125 extends radially outward. A tongue 127 projects radially outward from the rectangular segment 125. On the tongue 127 a supporting surface is formed which, when the clutch disk is in its assembled state, comes to rest against a corresponding supporting surface which is formed on the facing carrier element 121. The rectangular shaped segment 125 is bound laterally by two undulations 128 and 129. Laterally to the right from the undulation 129 a wing 131 extends, which is substantially complementary to a wing 132 which extends laterally to the left from the undulation 128. Wing 131 has a central window 133 that is substantially rectangular in shape. Above and below the window 133, undulations 134, 135 extend in the direction of a radial. Parallel to the undulations 134 and 135, wing 131 has an undulation 136.

Wing 132 is equipped with a window 138 which is substantially in the shape of a rectangle. Above window 138 wing 132 has an essentially rectangular cutout 139, which is open toward the outside. In addition there are three undulations 141 through 143 in wing 132, which run in the direction of a radial. The undulations 141 and 142, like the undulations 134, 135, spread out into the plane of the paper.

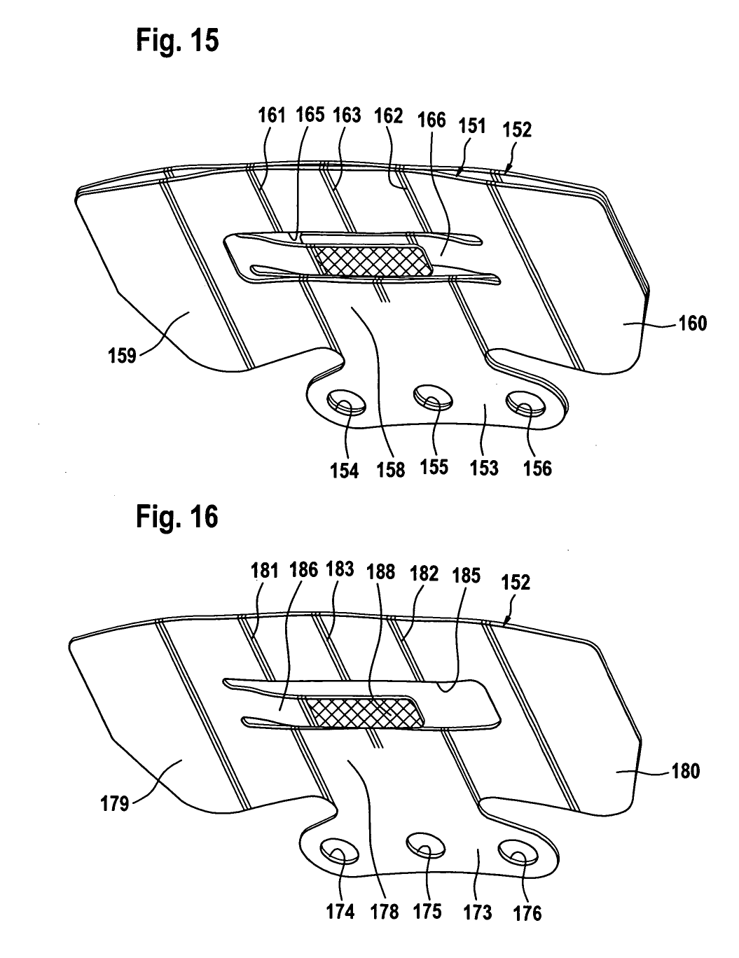

FIG. 15 shows two facing carrier elements 151, 152 in the assembled state, which are identically constructed. Facing carrier element 151 has a mount segment 153, which is provided with three clearance holes 154, 155, 156. From mount segment 153 extends a substantially rectangular segment 158, from which two wings 159, 160 extend laterally. The rectangular segment 158 is bound laterally by two undulations 161 and 162, which run in the direction of a radial. Parallel to undulations 161 and 162 extends an undulation 163, centered between the two undulations 161 and 162. Over the entire width of the rectangular segment 158, a window 165 extends clear into the wings 159, 160.

It can be seen in FIG. 16 that facing carrier element 152 is constructed exactly like facing carrier element 151. Facing carrier element 152 has a mount segment 173, which is provided with three clearance holes 174 through 176. An essentially rectangular shaped segment 178 extends upward in the radial direction from mount segment 173. From rectangular shaped segment 178, in turn, two wings 179,180 extend laterally. The rectangular segment 178 is bound laterally by two undulations 183, 182, which extend in the direction of a radial. Parallel to and centered between undulations 181, 182 extends an undulation 183 in the rectangular shaped segment 178. An elongated, essentially rectangular shaped window 185 extends over the entire width of the rectangular shaped segment 178. A tongue 186 extends from the left edge of the window 185. On the side facing the observer, the tongue 186 has a facing cementing surface 188.

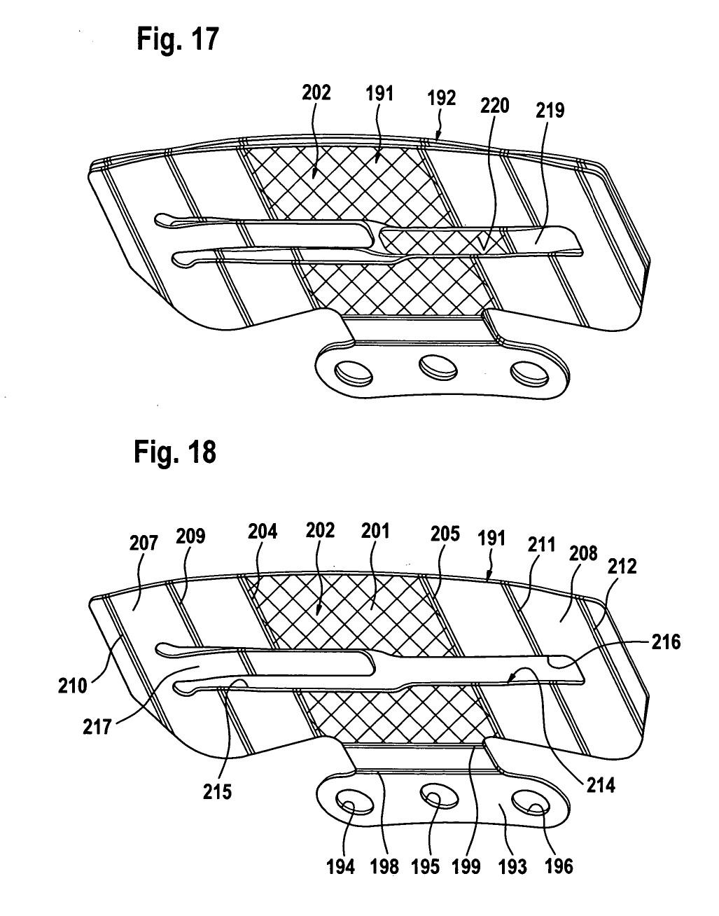

FIG. 17 shows two facing carrier elements 191, 192 in the assembled state. The two facing carrier elements 191, 192 are identical in design and, like all the exemplary embodiments shown in FIGS. 13 through 33, are pretensioned against each other in pairs in the axial direction. The construction and function of the facing carrying element 191 will be explained below on the basis of the exemplary embodiment shown in FIG. 18.

In FIG. 18 it can be seen that facing carrier element 191 has a mount segment 193 with three clearance holes 194 through 196. Mount segment 193 is separated from an essentially rectangular shaped segment 201 by two undulations 198, 199 that run perpendicular to a radial. Segment 201 has a flat facing mount surface 202 which is visible to the observer. Facing mount surface 202 is bound laterally by undulations 204, 205, which run in the direction of a radial. Two wings 207 and 208 extend laterally from segment 201. Wing 207 has two undulations 209, 210 that run parallel to undulations 204 and 205. Wing 208 likewise has two undulations 211, 212 that also run parallel to undulations 204 and 205. Finally, segment 201 has an elongated window 214 that extends perpendicular to a radial over the entire width of segment 201 clear into the tongues 207 and 208, which are also called wings. The left half 215 of window 214 has a somewhat greater height than the right half 216 of window 214. In the left half 215 there is a tongue 217, which projects from the left edge of window 214 and is offset in the axial direction into the plane of the sheet relative to facing mount surface 202.

In FIG. 17 it can be seen that on facing carrier element 192 a tongue 219 is formed in the same way as on facing carrier element 191, with a facing mount surface 220 which is turned toward the observer. So it is possible in the exemplary embodiment shown in FIG. 17 for one and the same clutch facing to be attached to different facing carrier elements 191 and 192 on facing mount surfaces 202 and 220.

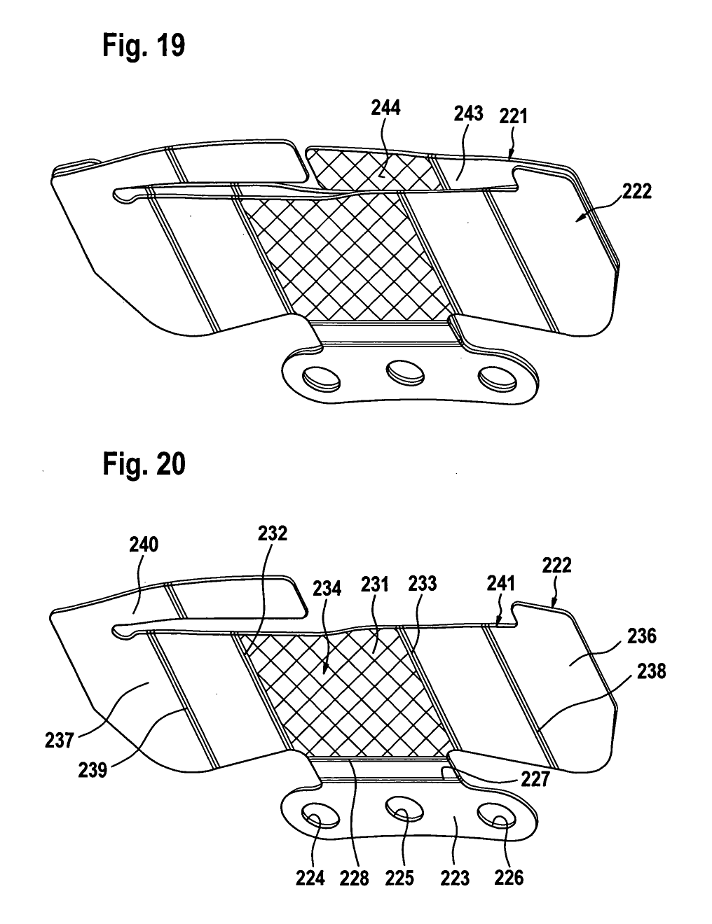

FIG. 19 shows two facing carrier elements 221, 222 in the assembled state. The construction and function of the identically designed carrier elements 221 and 222 is explained on the basis of the exemplary embodiment shown in FIG. 20.

In FIG. 20 it can be seen that facing carrier element 222 has a mount segment 223 with three clearance holes 224 through 226. An essentially rectangular shaped segment 231 is separated from mount segment 223 by undulations 227, 228, which run parallel to a radial. The essentially rectangular shaped segment 231 is bound laterally by undulations 232, 233. A wing 236 extends outward in the circumferential direction from undulation 233. A wing 237 extends from undulation 232 in the opposite direction. In addition, undulations 232, 233, which run in the direction of a radial, bound a facing cementing surface 234, which is shown with crosswise hatching. Wings 236, 237 have continuous undulations 238, 239 that run parallel to undulations 232, 233. A tongue 240 extends from the left wing 237 at the radially outward side, i.e., at the top in FIG. 20, which extends from the outside toward the inside. On the side opposite the tongue 240 the wing 236 has a cutout 241 whose purpose is to guide a tongue 243 (see FIG. 19) with a facing cementing surface 244 past that is formed on the facing carrier element 221.

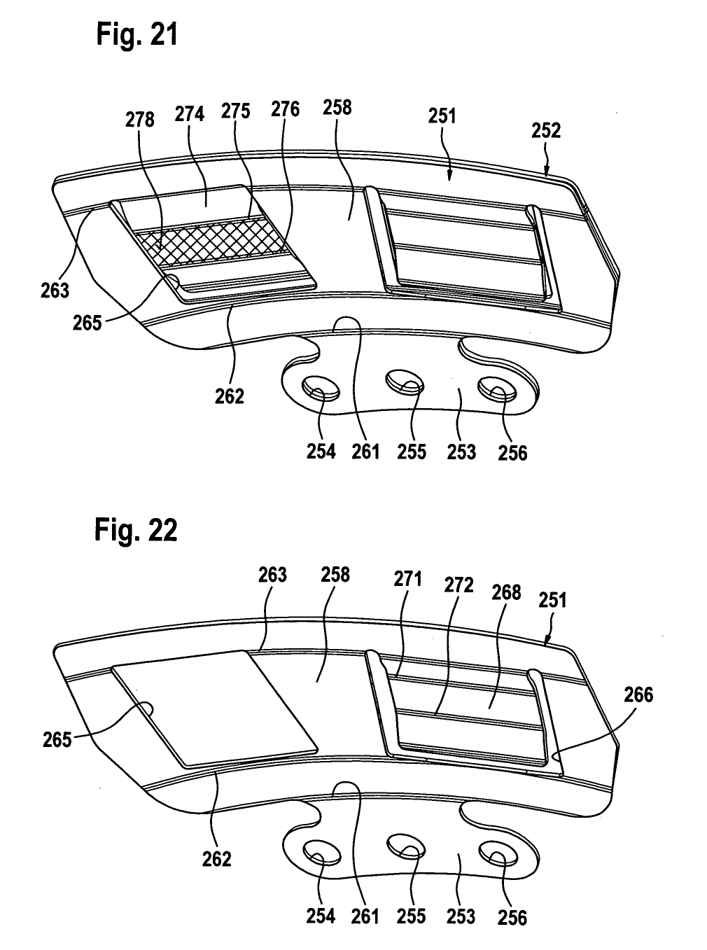

FIG. 21 shows two facing carrier elements 251, 252 in the assembled state and tensioned against each other axially. The construction and function of the identically designed facing carrier elements 251, 252 is explained below on the basis of the facing carrier element 251 shown in FIG. 22.

The facing carrier element 251 shown alone in FIG. 22 has a mount segment 253 with three clearance holes 254 through 256. The mount segment 253 is bound by an undulation 261 running in the circumferential direction. Coaxial to undulation 261 the facing carrier element 251 has additional undulations 262, 263, which also run in the circumferential direction. The term circumferential direction refers to the rotational axis of the clutch disk (1 in FIG. 1). Two essentially rectangular shaped windows 265, 266 are formed in facing carrier element 251 within the undulations 262, 263. An essentially rectangular shaped tongue 268 extends downward from the upper edge of window 266. The tongue 268 is shaped so that it arches into the plane of the drawing. For this purpose, the tongue 268 has two undulations 271, 272 that run perpendicular to a radial.

It can be seen in FIG. 21 that the facing carrier element 252 likewise has a tongue 274, which has undulations 275 and 276. The undulations 275 and 276 bound a facing mount surface 278, which is turned toward the observer of FIG. 21. The facing mount surface 278, which extends from the tongue 274 of the facing carrier element 252, is positioned in the window 265 of facing carrier element 251.

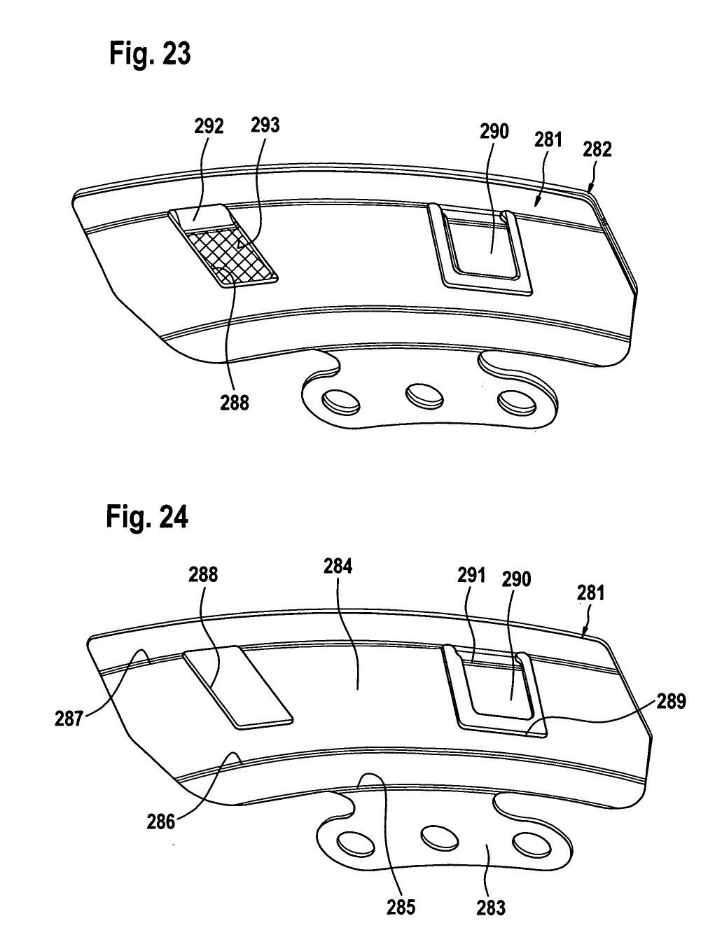

FIG. 23 shows two facing carrier elements 281 and 282 in the assembled state and pretensioned against each other axially. The two facing carrier elements 281 and 282 are identical in design. The construction and function of the facing carrier elements 281, 282 is explained below on the basis of the facing carrier element 281 shown by itself in perspective view in FIG. 24.

In FIG. 24 it can be seen that facing carrier element 281 includes a mount segment 283 with three clearance holes. Mount segment 283 is separated from an essentially rectangular shaped segment 284 by two undulations 285 and 286 that run in the circumferential direction. Coaxial to the undulations 285 and 286, an undulation 287 also runs in the circumferential direction. Two essentially rectangular shaped windows 288, 289 are cut out in facing carrier element 281 within the undulations 287 and 286. A tongue 290 extends downward from the upper edge of window 289. The tongue 290 is curved into the drawing plane, compared to segment 284, by an undulation 291.

In FIG. 23 it can be seen that when facing carrier elements 281, 282 are in the assembled state a tongue 292 is positioned in window 288 of facing carrier element 281 with a facing cementing surface 293 facing toward the observer.

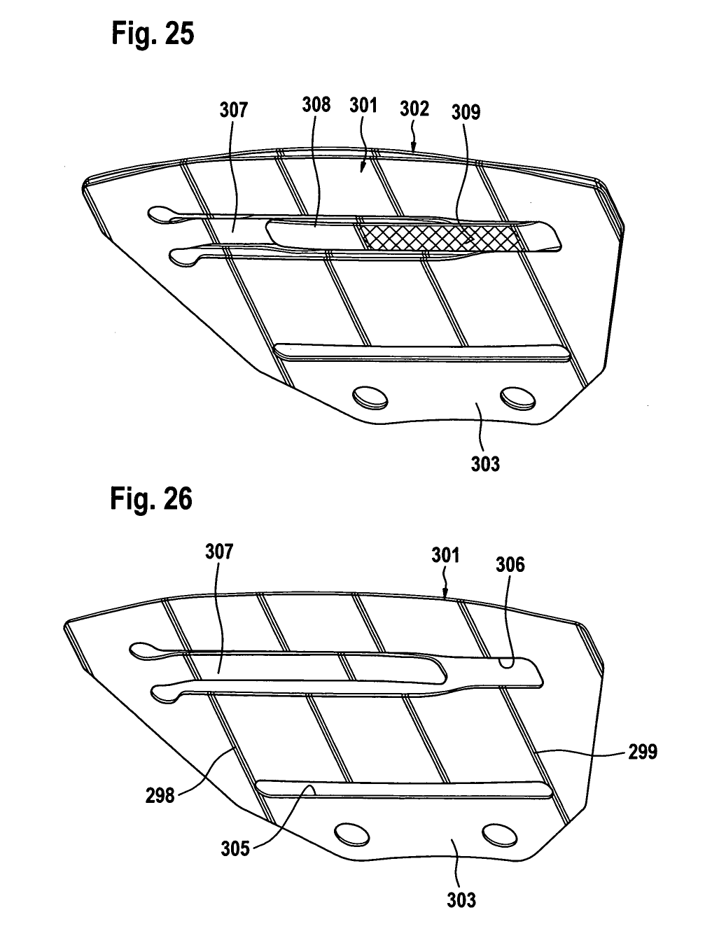

FIG. 25 shows two facing carrier elements 301, 302 in the assembled state. The two facing carrier elements 301, 302, which are pretensioned against each other in the axial direction, are identical in design. The construction and function of the facing carrier elements 301, 302 is explained below on the basis of the facing carrier element 301 shown by itself in FIG. 26.

In FIG. 26 it can be seen that facing carrier element 301 includes a mount segment 303 with two clearance holes. Mount segment 303 is separated from the rest of facing carrier element 301 by a slot 305 running perpendicular to a radial. facing mount segment 303 is bound laterally by undulations 298, 299, which run in the direction of a radial. Radially outside of, i.e., above the slot 305, facing carrier element 301 has an elongated window 306, which extends parallel to a slot 305 perpendicular to a radial. A tongue 307 extends from the left edge of the window 306.

In FIG. 25 it can be seen that the free end of a tongue which extends from facing carrier element 302 is in contact with the tongue 307 of facing carrier element 301. On the side of tongue 308 facing the observer a facing mount surface 309 is formed, which is shown with crosswise hatching.

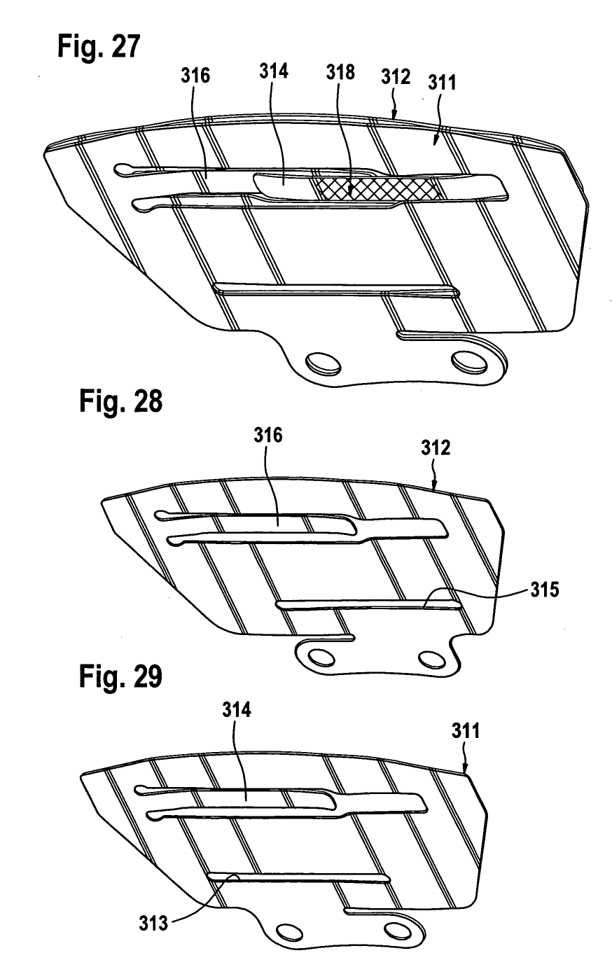

FIG. 27 shows two facing carrier elements 311, 312 in the assembled state and pretensioned against each other. The two facing carrier elements 311 and 312 are not identical in design. For that reason the two facing carrier elements 311, 312 are each shown alone in the following FIGS. 28 and 29.

In FIG. 29 it can be seen that facing carrier element 311 has a mount segment that is bound radially toward the outside by a slot 313 that runs perpendicular to a radial. In a manner similar to the exemplary embodiment shown in FIG. 26, facing carrier element 311 has a tongue 314 which is positioned in a longitudinal window of facing carrier element 311.

In FIG. 28 it can be seen that facing carrier element 312 has a slot 315 and a tongue 316 in the same way. In the assembled state, as shown in FIG. 27, the free end of the tongue 314 of facing carrier element 311 comes into contact with the tongue 316 of facing carrier element 312. On the side of tongue 314 turned toward the observer there is a facing cementing surface 318, which is shown with crosswise hatching.

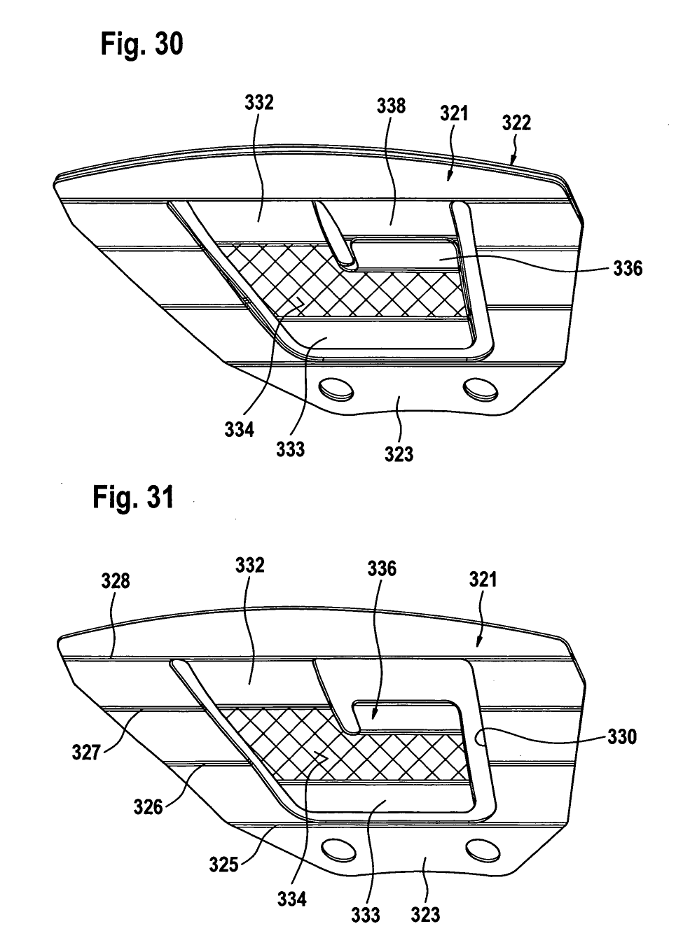

FIG. 30 shows two facing carrier elements 321, 322 in the assembled state and pretensioned against each other axially. The two facing carrier elements 321 and 322 are identical in design. The construction and function of facing carrier element 321 are explained below on the basis of its depiction alone in FIG. 31.

In FIG. 31 it can be seen that facing carrier element 321 has a mount segment 323 with two clearance holes. Furthermore, facing carrier element 321 has undulations 325 through 328, which run perpendicular to a radial. A window 330 is cut out of facing carrier element 321. A tongue 332 extends downward from the upper edge of window 330. Tongue 332 has substantially the shape of a ∪ 333. Tongue 332 has a facing cementing surface 334 in the area of the ∪ 333 on the side turned toward the observer.

In FIG. 30 it can be seen that the free end 336 of tongue 332 of the facing carrier element 321 is in contact with a tongue 338 of facing carrier element 322.

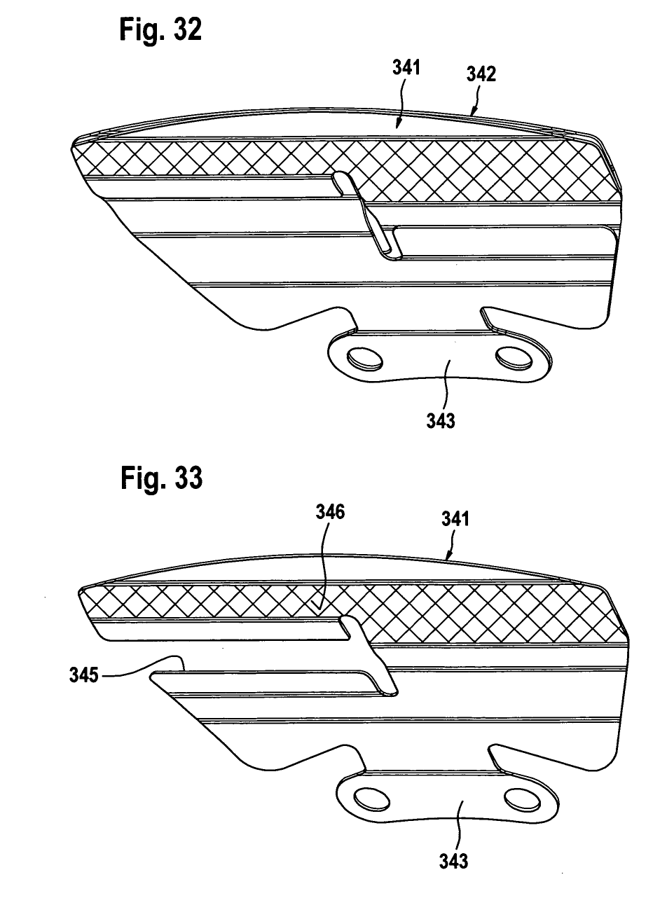

FIG. 32 shows two facing carrier elements 341, 342 in the assembled state and pretensioned against each other axially. The two facing carrier elements 341, 342 are identical in design. The construction and function of facing carrier element 341 are explained below on the basis of its depiction alone in FIG. 33.

In FIG. 33 it can be seen that facing carrier element 341 has a mount segment 343 with two clearance holes. In contrast to the previous exemplary embodiments, facing carrier element 341 has an essentially T-shaped notch 345. Above the T-shaped notch 345 facing carrier element 341 has a facing cementing surface 346, which is shown with crosswise hatching and is turned toward the observer. Furthermore, facing carrier element 341 has a plurality of undulations, which run perpendicular to a radial.

Although particular embodiments of the present invention have been illustrated and described, it will be apparent to those skilled in the art that various changes and modifications can be made without departing from the spirit of the present invention. It is therefore intended to encompass within the appended claims all such changes and modifications that fall within the scope of the present invention.

What is claimed is:

1. A clutch for use in a motor vehicle clutch, said clutch comprising: a carrier plate to which facing carrier elements are attached that are pretensioned against each other in the axial direction and that have, on sides that are turned away from each other in the axial direction, at least one facing mount surface to which at least one clutch facing is attached, characterized in that the facing carrier elements on the side that is turned away from the facing mount surface in the axial direction each have at least one facing contact surface for a clutch facing which is positioned opposite the clutch facing that is attached to the respective facing carrier element.

2. A clutch disk in accordance with claim 1, wherein the facing mount surface is a cementing surface.

3. A clutch disk in accordance with claim 1, wherein the facing contact surface is spaced from the facing mount surface by at least one corrugation.

4. A clutch disk in accordance with claim 1, wherein the facing mount surface of one facing carrier element is positioned between two supporting surfaces on which corresponding supporting surfaces of at least one additional facing carrier element are supported.

5. A clutch disk in accordance with claim 1, including a step formed in the facing carrier element between the facing mount surface and the facing contact surface.

6. A clutch disk in accordance wit claim 5, wherein the dimension of the step in the axial direction corresponds approximately to the material thickness of the facing carrier element.

7. A clutch disk in accordance with claim 1, wherein the facing carrier elements each have a substantially right-angled cutout.

8. A clutch disk in accordance with claim 1, wherein when the clutch disk is in its assembled state the facing carrier elements each have two tongues radially inside of the facing mount surface, on each of which tongues there is at least one facing mount surface for a clutch facing that is located opposite the clutch facing which is attached to the respective facing carrier element.

9. A clutch disk in accordance with claim 1, wherein when the clutch disk is in its assembled state the facing carrier elements each have two tongues radially outside of the facing mount surface, on each of which tongues there is at least one facing contact surface for a clutch facing that is located opposite the clutch facing which is attached to the respective facing carrier element.

10. A clutch disk in accordance with claim 1, wherein when the clutch disk is in its assembled state the facing carrier elements are each engaged with the facing carrier elements that are adjacent in the circumferential direction.

11. A clutch disk in accordance with claim 1, wherein when the clutch disk is in its assembled state the facing carrier elements each have at least one window that serves to receive the facing contact surface for the clutch facing that is opposite the clutch facing that is attached to the particular facing carrier element.

12. A clutch disk in accordance with claim 1, wherein the facing carrier elements each have at least one tongue on which the facing contact surface is provided for the clutch facing that is opposite the clutch facing that is attached to the particular facing carrier element.

13. A clutch disk in accordance with claim 1, wherein all facing carrier elements have the same shape.

14. A clutch disk in accordance with claim 1, wherein the facing carrier elements each have a mount segment radially on the inner side.

15. A clutch disk in accordance with claim 1, wherein the facing carrier elements are each made of spring steel in a single piece.
